(19) United States
(12) Patent Application Publication
(10) Pub. No.: US 2017/0061379 A1
(43) Pub. Date: Mar. 2, 2017

(54) SYSTEMS AND METHODS FOR MASTER-CLIENT VIRTUAL WORKSPACE COMMUNICATION AND MANAGEMENT

(71) Applicant: Magnum Software Development, Ltd., Esher (GB)

(72) Inventors: Graham Smith-Bernal, Esher (GB); Steven Fleming, New York, NY (US)

(73) Assignee: Magnum Software Development, Ltd., Esher (GB)

(21) Appl. No.: 15/250,547

(22) Filed: Aug. 29, 2016

Related U.S. Application Data
(60) Provisional application No. 62/211,646, filed on Aug. 28, 2015.

(51) Int. Cl. G06Q 10/10; H04L 29/06; G06Q 30/06

(52) U.S. Cl. CPC G06Q 10/103; G06Q 30/06; H04L 63/101

(57) ABSTRACT

A content object may be received from a remote system associated with a seller associated with a sale. The content object may be stored in a content object datastore. A master virtual workspace may be generated and associated with the seller. A client virtual workspace may be generated from the master virtual workspace and associated with one or more buyers. The master virtual workspace may comprise a first instance of the content object, and the client virtual workspace may comprise a second instance of the content object. A buyer annotation unavailable to the master virtual workspace may be generated and associated with the second instance. A buyer comment may be generated including a link to the content object. It may be determined whether a first buyer has permission to publish the buyer comment to the master virtual workspace. If the first buyer has permission, the buyer comment may be published.

### CROSS-REFERENCE TO RELATED APPLICATIONS

The present application claims the benefit of U.S. Provisional Patent Application Ser. No. 62/211,646, filed Aug. 28, 2015 and entitled “Opus2 Forum Functionality, Architecture, and Implementation,” which is hereby incorporated by reference herein.

### BACKGROUND

Technical Field

Embodiments of the present invention relate generally to the field of virtual workspaces. More specifically, embodiments of the present inventions relate to master-client virtual workspace communication and management.

Description of Related Art

Physical data rooms have traditionally been used to store and share sensitive documents in support of privileged transactions (e.g., mergers and acquisitions). Typically, physical data rooms allow parties to a transaction to visit the data room, inspect documents, share information, and so forth. However, physical data rooms are inconvenient and costly, and have led to increased use of virtual data rooms. Although current virtual data rooms provide some benefit over traditional physical data rooms, they also suffer from a variety of drawbacks, including poor security and access control, an inability to efficiently share information and control information sharing, cumbersome user interfaces, and the like.

### SUMMARY

Physical data rooms have traditionally been used to store and share sensitive documents in support of privileged transactions (e.g., mergers and acquisitions). Typically, physical data rooms allow parties to a transaction to visit the data room, inspect documents, share information, and so forth. However, physical data rooms are inconvenient and costly, and have led to increased use of virtual data rooms. Although current virtual data rooms provide some benefit over traditional physical data rooms, they also suffer from a variety of drawbacks, including poor security and access control, an inability to efficiently share information and control information sharing, cumbersome user interfaces, and the like.

Some embodiments described herein include systems and methods for creating and managing master-client virtual workspaces, and providing communications between master-client virtual workspaces. In one example, such systems and methods may be used in mergers and acquisitions transactions. For example, a seller may be associated with a master virtual workspace, and one or more buyers may each be associated with their own client virtual workspace. In some embodiments, the seller may provide documents to a secure central datastore, view and edit documents, and define access control permissions for virtual workspaces and documents, all through the master virtual workspace. Depending on the access control permissions defined by the seller, buyers may access instances of the document through their respective client virtual workspace. Similarly, buyers may also define access control permissions within their associated client virtual workspace.

In some embodiments, buyers can annotate instances of the documents local to their client virtual workspace without modifying the documents themselves (i.e., the documents stored in the secure central datastore). This can allow, for example, buyers to provide private notes that are not available to the master virtual workspace or other client virtual workspaces. Additionally, in some embodiments, buyers and sellers may communicate with each other through their respective virtual workspaces. For example, a buyer can provide comments (e.g., questions) from their client virtual workspace to a master virtual workspace, and the seller may selectively reply. In some embodiments, providing comments depends on access control permissions. For example, a particular buyer (e.g., a junior buyer team member) may have sufficient permission to draft a comment, but another buyer (e.g., a senior buyer team member) may be required in order to publish the comment to the master virtual workspace.

In various embodiments, a system comprises a processor and a content object datastore. An import engine may be configured to cooperate with the processor to receive a content object from a remote system associated with a seller, the seller associated with a sale. A management engine may be configured to store the content object in the content object datastore. A master-client virtual workspace generation engine may be configured to generate a master virtual workspace associated with the seller, and configured to generate a client virtual workspace from the master virtual workspace, the client virtual workspace associated with one or more buyers, the one or more buyers associated with the sale, the master virtual workspace comprising a first instance of the content object, and the client virtual workspace comprising a second instance of the content object. A master-client virtual workspace annotation engine may be configured to generate a buyer annotation, and configured to associate the buyer annotation with the second instance of the content object, the buyer annotation unavailable to the master virtual workspace. A master-client virtual workspace comment generation engine may be configured to generate a buyer comment, the buyer comment including a link to the content object, the buyer comment received from a first buyer of the one or more buyers. An access control engine may be configured to determine whether the first buyer of the one or more buyers has sufficient permission to publish the buyer comment to the master virtual workspace. A master-client virtual workspace comment publication engine may be configured to publish the buyer comment to the master virtual workspace if the first buyer of the one or more buyers has the sufficient permission to publish the comment to the master virtual workspace.

In some embodiments, the buyer annotation comprises any of a text-based annotation associated with the content object, an image-based annotation associated with the content object, or markups overlaid over a content area of the content object.

In some embodiments, the buyer comment comprises a question directed to the seller. In related embodiments, a format of the question comprises any of text, audio, image, or video.

In some embodiments, the access control is configured to determine whether the first buyer of the one or more buyers has sufficient permission to publish the buyer comment to the master virtual workspace based on an access control list (ACL) associated with the client virtual workspace.

In some embodiments, the access control engine is configured to determine whether the first buyer of the one or more buyers has sufficient permission to publish the buyer comment to the master virtual workspace based on a user role associated with the first buyer of the one or more buyers.

In some embodiments, the master-client virtual workspace comment generation engine is configured to receive a seller reply to the buyer comment, the seller reply received from the seller through the master virtual workspace.

In some embodiments, the master virtual workspace comment publication engine is further configured to select one or more buyers to receive the seller reply, and publish the seller reply to the one or more client virtual workspaces associated with the one or more buyers. In related embodiments, the access control engine is further configured to determine, prior to the publication of the seller reply to the one or more client virtual workspaces associated with the one or more buyers, whether each of the one or more buyers have sufficient permission to access some or all of the seller reply, and redact one or more portions of the seller reply to a particular one of the one or more buyers if the particular one of the one or more buyers does not have sufficient permission to access some or all of the seller reply.

In various embodiments, a method comprises receiving, by a master-client virtual workspace management engine, a content object from a remote system associated with a seller, the seller associated with a sale. The content object may be stored in a content object datastore. A master virtual workspace may be generated and associated with the seller. A client virtual workspace may be generated from the master virtual workspace and associated with one or more buyers, the one or more buyers associated with the sale, the master virtual workspace comprising a first instance of the content object, and the client virtual workspace comprising a second instance of the content object. A buyer annotation may be generated and associated with the second instance of the content object, the buyer annotation unavailable to the master virtual workspace. A buyer comment may be generated, the buyer comment including a link to the content object, the buyer comment received from a first buyer of the one or more buyers. It may be determined whether the first buyer of the one or more buyers has sufficient permission to publish the buyer comment to the master virtual workspace. If the first buyer of the one or more buyers has sufficient permission to publish the comment to the master virtual workspace, the buyer comment may be published to the master virtual workspace.

In some embodiments, the buyer annotation comprises any of a text-based annotation associated with the content object, an image-based annotation associated with the content object, or markups overlaid over a content area of the content object.

In some embodiments, the buyer comment comprises a question directed to the seller. In related embodiments, a format of the question comprises any of text, audio, image, or video.

In some embodiments, the determining whether the first buyer of the one or more buyers has sufficient permission to publish the buyer comment to the master virtual workspace is based on an access control list (ACL) associated with the client virtual workspace.

In some embodiments, the determining whether the first buyer of the one or more buyers has sufficient permission to publish the buyer comment to the master virtual workspace is based on a user role associated with the first buyer of the one or more buyers.

In some embodiments, the method further comprises receiving a seller reply to the buyer comment, the seller reply received from the seller through the master virtual workspace. In related embodiments, the method further comprises selecting one or more buyers to receive the seller reply, and publishing the seller reply to the one or more client virtual workspaces associated with the one or more buyers. In related embodiments, the method further comprises, prior to the publishing of the seller reply to the one or more client virtual workspaces associated with the one or more buyers, whether each of the one or more buyers have sufficient permission to access some or all of the seller reply, and redacting one or more portions of the seller reply to a particular one of the one or more buyers if the particular one of the one or more buyers does not have sufficient permission to access some or all of the seller reply.

In various embodiments, a non-transitory computer readable medium comprising executable instructions, the instructions being executable by a processor to perform a method, the method comprising receiving, by a master-client virtual workspace management engine, a content object from a remote system associated with a seller, the seller associated with a sale. The content object may be stored in a content object datastore. A master virtual workspace may be generated and associated with the seller. A client virtual workspace may be generated from the master virtual workspace and associated with one or more buyers, the one or more buyers associated with the sale, the master virtual workspace comprising a first instance of the content object, and the client virtual workspace comprising a second instance of the content object. A buyer annotation may be generated and associated with the second instance of the content object, the buyer annotation unavailable to the master virtual workspace. A buyer comment may be generated, the buyer comment including a link to the content object, the buyer comment received from a first buyer of the one or more buyers. It may be determined whether the first buyer of the one or more buyers has sufficient permission to publish the buyer comment to the master virtual workspace. If the first buyer of the one or more buyers has sufficient permission to publish the comment to the master virtual workspace, the buyer comment may be published to the master virtual workspace.

### BRIEF DESCRIPTION OF THE DRAWINGS

FIG. 1 depicts a block diagram of an example system capable of creating and managing master-client virtual workspaces according to some embodiments.

FIG. 2 depicts a block diagram of an example master-client virtual workspace management system according to some embodiments.

FIG. 3 depicts a flowchart of an example method of operation of a master-client virtual workspace management system according to some embodiments.

FIG. 4 depicts a flowchart of an example method of operation of a master-client virtual workspace management system according to some embodiments.

FIG. 5 depicts a flowchart of an example method of operation of a master-client virtual workspace management system according to some embodiments.

FIG. 6 depicts a flowchart of an example method of operation of a master-client virtual workspace management system according to some embodiments.

FIG. 7 depicts a screenshot of an example interface associated with a master virtual workspace according to some embodiments.

FIG. 8 depicts a screenshot of an example interface associated with a master virtual workspace according to some embodiments.

FIG. 9 depicts a screenshot of an example interface associated with a master virtual workspace according to some embodiments.

FIG. 10 depicts a block diagram of an example computing device according to some embodiments.

### DETAILED DESCRIPTION

Physical data rooms have traditionally been used to store and share sensitive documents in support of privileged transactions (e.g., mergers and acquisitions). Typically, physical data rooms allow parties to a transaction to visit the data room, inspect documents, share information, and so forth. However, physical data rooms are inconvenient and costly, and have led to increased use of virtual data rooms. Although current virtual data rooms provide some benefit over traditional physical data rooms, they also suffer from a variety of drawbacks, including poor security and access control, an inability to efficiently share information and control information sharing, cumbersome user interfaces, and the like.

Some embodiments described herein include systems and methods for creating and managing master-client virtual workspaces, and providing communications between master-client virtual workspaces. In one example, such systems and methods may be used in mergers and acquisitions transactions. For example, a seller may be associated with a master virtual workspace, and one or more buyers may each be associated with their own client virtual workspace. In some embodiments, the seller may provide documents to a secure central datastore, view and edit documents, and define access control permissions for virtual workspaces and documents, all through the master virtual workspace. Depending on the access control permissions defined by the seller, buyers may access instances of the document through their respective client virtual workspace. Similarly, buyers may also define access control permissions within their associated client virtual workspace.

In some embodiments, buyers can annotate instances of the documents local to their client virtual workspace without modifying the documents themselves (i.e., the documents stored in the secure central datastore). This can allow, for example, buyers to provide private notes that are not available to the master virtual workspace or other client virtual workspaces. Additionally, in some embodiments, buyers and sellers may communicate with each other through their respective virtual workspaces. For example, a buyer can provide comments (e.g., questions) from their client virtual workspace to a master virtual workspace, and the seller may selectively reply. In some embodiments, providing comments depends on access control permissions. For example, a particular buyer (e.g., a junior buyer team member) may have sufficient permission to draft a comment, but another buyer (e.g., a senior buyer team member) may be required in order to publish the comment to the master virtual workspace.

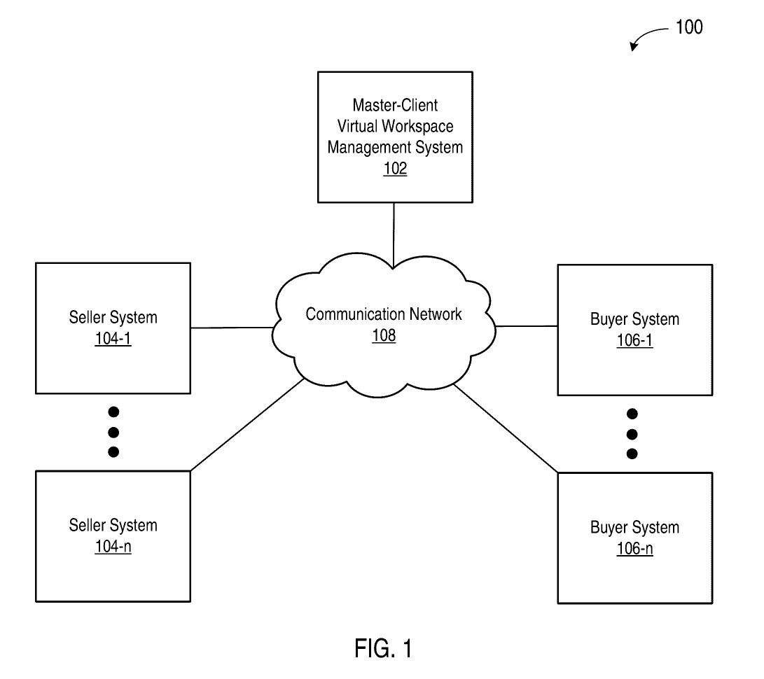

FIG. 1 depicts a block diagram of an example system 100 capable of creating and managing master-client virtual workspaces according to some embodiments. The system 100 includes a master-client virtual workspace management system 102, seller systems 104-1 to 104-n (individually, the seller system 104, collectively, the seller systems 104), buyer systems 106-1 to 106-n (individually, the buyer system 106, collectively, the buyer systems 106), and a communication network 108.

The master-client virtual workspace management system 102 may be configured to create and manage master-client virtual workspaces to facilitate various types of transactions (e.g., mergers and acquisitions). In some embodiments, functionality of the master-client virtual workspace management system 102 is performed by one or more servers, workstations, desktop computers, laptop computers, mobile devices, or the like. In some embodiments, master-client virtual workspaces include a master virtual workspace and one or more client virtual workspaces associated with the master virtual workspace. For example, a client virtual workspace can be a “mirror” of a master virtual workspace, or otherwise generated from a master virtual workspace. It will be appreciated that master virtual workspaces and client virtual workspace may collectively be referred to as master-client virtual workspaces.

In some embodiments, the master-client virtual workspace management system 102 associates a seller with a master virtual workspace, and a buyer with a client virtual workspace, or vice versa. It will be appreciated that a seller may include one or more different entities. For example, a seller may comprise the seller (e.g., the owner of an asset at issue in a transaction), a professional associated with the seller (e.g., an attorney or other representative of the seller, a consultant, etc.), and the like. Similarly, a buyer may also include one or more different entities. For example, a buyer may comprise the buyer, a professional associated with the buyer, and the like. It will further be appreciated that buyers may also include potential buyers, as well as those who actually complete a transaction. Although sellers and buyers are discussed herein, it will be appreciated that other types of users or groups of users may also be associated with master-client virtual workspaces. In various embodiments, a “user” includes a seller, buyer, groups of sellers, and/or groups of buyers. For example, a group of sellers may be a seller team (e.g., the seller, the seller's representatives, etc.), and a group of buyers may be a buyer team (e.g., the buyer, the buyer's representatives, etc.).

In some embodiments, the master-client virtual workspace management system 102 is configured to provide permission-based access to content objects. In some embodiments, a content object is an object that includes content from any kind of electronic media, including documents, spreadsheets, photographs, video, audio, presentations, and/or the like. In one example, a content object is a discrete file.

In some embodiments, the master-client virtual workspace management system 102 is configured to provide permission-based communication between master virtual workspaces and client virtual workspaces. In some embodiments, the communication may be provided using comments (or, “questions”). For example, a buyer may provide a comment through the client virtual workspace and, depending on the permissions associated with the buyer, publish the comment to a master virtual workspace. If the buyer has insufficient permissions, another buyer with sufficient permission (e.g., a senior buyer team member associated with the client virtual workspace) may publish the comment.

In some embodiments, the master-client virtual workspace management system 102 is configured to capture buyer activity within client virtual workspaces. For example, buyer activity may include the number of times a buyer has viewed particular documents, the number of comments provided by a buyer, and so forth. In some embodiments, the master-client virtual workspace management system 102 is configured to generate reports based on captured activity. For example, reports may indicate which buyers are legitimate buyers, as opposed to buyers that may merely be trolling for information.

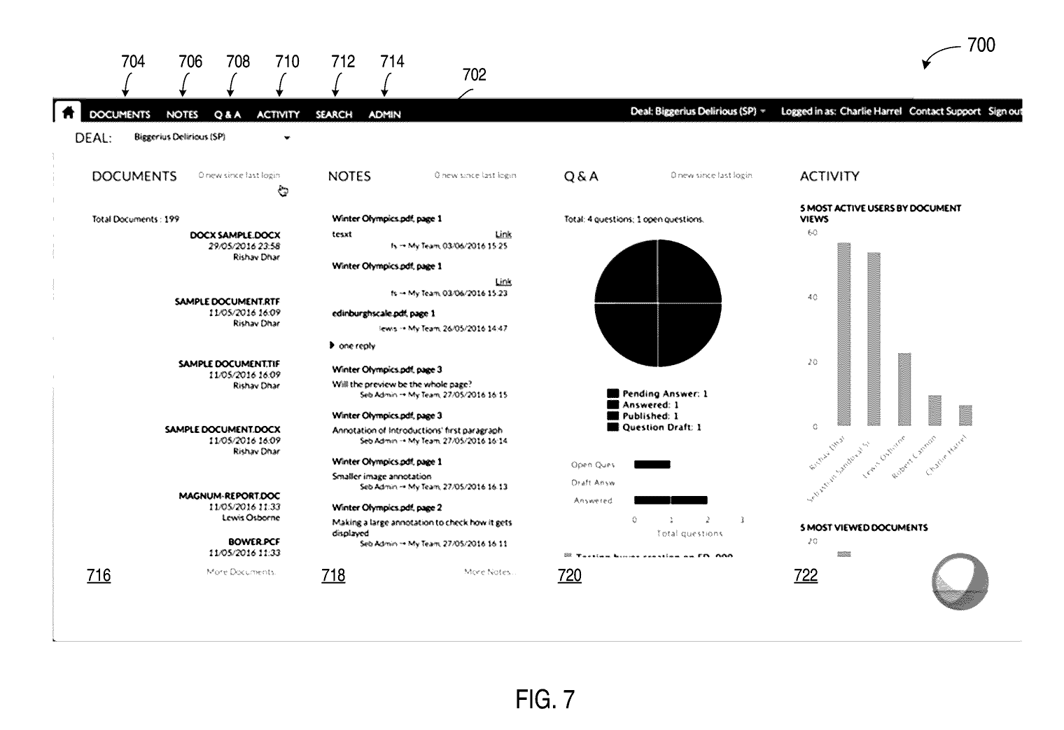

In some embodiments, the master-client virtual workspace management system 102 is configured to provide a user interface associated with a corresponding master virtual workspace or client virtual workspace. For example, the interface may comprise a graphical “dashboard” interface, e.g., as shown in FIGS. 7-9. The interface may be navigated to access content objects, define access control permissions, provide and respond to comments, provide annotations, and otherwise utilize the features and tools of the associated master-client virtual workspace.

The seller systems 104 may be configured to communicate with one or more other systems over a communication network. In some embodiments, the functionality of the seller systems 104 may be performed by one or more mobile devices (e.g., smartphones, cell phones, smartwatches, tablet computers, or the like), desktop computers, laptop computers, and the like. In some embodiments, a seller may interact with an associated seller system 104 (e.g., via a web browser or mobile application executing on the seller system 104) to communicate with buyers through a master virtual workspace executing on a remote system. For example, sellers may be able to upload documents, control access permissions, and receive and respond to communications from different buyers.

The buyer systems 106 may be configured to communicate with one or more other systems over a communication network. In some embodiments, the functionality of the buyer systems 106 may be performed by one or more mobile devices (e.g., smartphones, cell phones, smartwatches, tablet computers, or the like), desktop computers, laptop computers, and the like. In some embodiments, a buyer may interact with an associated buyer system 106 (e.g., via a web browser or mobile application executing on the buyer system 106) to communicate with sellers through a client virtual workspace executing on a remote system. For example, buyers may be able view documents, control access permissions for buyer team members, and provide and receive communications with sellers.

In some embodiments, the communication network 108 represents one or more computer networks (e.g., LAN, WAN, or the like). The communication network 108 may provide communication between any of the master-client virtual workspace management system 102, the seller systems 104, and the buyer systems 106. In some implementations, the communication network 108 comprises computing devices, routers, cables, buses, and/or other network topologies. In some embodiments, the communications network 108 may be wired and/or wireless. In various embodiments, the communications network 108 may comprise the Internet, one or more networks that may be public, private, IP-based, non-IP based, and so forth.

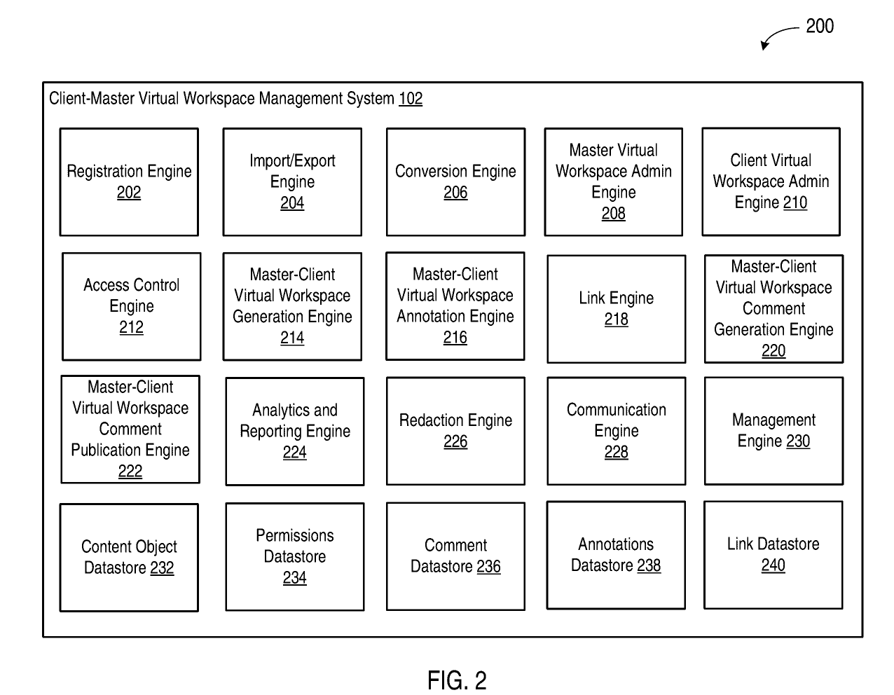

FIG. 2 depicts a block diagram 200 of an example master-client virtual workspace management system 102 according to some embodiments. In some embodiments, the master-client virtual workspace management system 102 includes a registration engine 202, an import/export engine 204, a conversion engine 206, a master virtual workspace administration engine 208, a client virtual workspace administration engine 210, an access control engine 212, a master-client virtual workspace generation engine 214, a master-client virtual workspace annotation engine 216, a link engine 218, a master-client virtual workspace comment generation engine 220, a master-client virtual workspace publication engine 222, an analytics and reporting engine 224, a redaction engine 226, a communication engine 228, a management engine 230, a content object datastore 232, a permissions datastore 234, a comment datastore 236, an annotations datastore 238, and a link datastore 240.

The registration engine 202 may be configured to create accounts for sellers and buyers, and/or update account information for sellers and buyers. For example, the accounts may include attribute information (e.g., account credentials, and the like). In some embodiments, registration may be required in order to access various features of an associated client-master virtual workspace. For example, registration may be required for a buyer to be associated with a client virtual workspace, and/or a seller to be associated with master virtual workspace.

In some embodiments, registration may be public or private. For example, private registration may require an invitation from a registered seller in order to register a buyer account. This may help reduce accidental dissemination of content, and reduce the likelihood of attracting “fake” buyers that are merely trawling for information.

The import/export engine 204 may be configured to import content and/or content objects into the master-client virtual workspace management system 102, or export content or content objects from the master-client virtual workspace management system 102. For example, the import/export engine 204 may receive the content from a database or an application external to the master-client virtual workspace management system 102.

Through the import/export engine 204, the master-client virtual workspace management system 102 may automatically import the content or content object, into the master-client virtual workspace management system 102, at or near a time a user requests access (e.g., via an interface) to the content and/or information from a content object (e.g., importation is performed just-in-time for access). For example, a seller, through an interface associated with the master virtual workspace, may view content that is available only on a remote digital device and/or seek to add content not previously available. The import/export engine 204 may retrieve content from the remote digital device and/or receive new content not previously available (e.g., by adding a file not previously linked to the master-client virtual workspace management system 102).

The import/export engine 204 may perform the importation process in advance of the seller's request for access to the content and/or content object. For instance, at the request of a seller, the content and/or content object(s) may be imported into the master-client virtual workspace management system 102 in advance of the seller's access request. Furthermore, the master-client virtual workspace management system 102 may automatically (e.g., without requiring user input) import content and/or content objects through the import/export engine 204 based on a predetermined schedule (e.g., hourly, daily, monthly, or the like). In some embodiments, imported content may be stored persistently (e.g., in content object datastore 232) within one or more content objects to facilitate online and offline access of the content and/or content object by any number of sellers and/or buyers.

The content and/or content object received by the import/export engine 204 may be in any format. For example, content and/or a content object may be in a PostScript Document Format (PDF), Excel spreadsheet, MS Word document, MPEG file, and the like. In some embodiments, upon receiving the content, the import/export engine 204 may index the content for access by one or more sellers or buyers. For instance, the import/export engine 204 may add content and/or a newly generated content object to an index that lists content and/or content objects available for access through the master-client virtual workspace management system 102. The import/export engine 204 may be further configured to index content of the content object, thereby enabling the content object to be sought and located.

In various embodiments, the import/export engine 204 may collect information relating to or associated with the content and/or content object as the content and/or content object is received by the master-client virtual workspace management system 102. Exemplary information that may be collected for (and from) the content and/or content object may include metadata of the content and/or content object, a link embedded in the content and/or content object (e.g., hyperlinks), an annotation embedded in the content and/or content object (e.g., embedded comments for a Microsoft® Word document).

Once collected, the import/export engine 204 may provide such information to the management engine 212 for storage and/or association with the content and/or content object. For some embodiments, such information may be stored in a database and associated in the database with the content and/or content object. Additionally, for some embodiments, such information may be stored in a flat file (e.g., CSV file), which may be located in the same storage location (e.g., directory or storage device) as the content and/or content object and which may be associated with the content and/or content object by way of a file naming convention (e.g., name the flat file similarly to the content and/or content object). Furthermore, a flat file storing the collected information may be associated with the content and/or content object by way of a database or datastore configured to store such an association.

In various embodiments, when the content object is accessed by the user (e.g., seller and/or buyer), information stored on the master-client virtual workspace management system 102 relating to or associated with the content object may be recalled and utilized as part of the access process. For instance, the stored information may be used in allowing or denying a user access to certain content objects on the master-client virtual workspace management system 102. For example, where stored information indicates the content objects contain confidential sales information and the access management engine 208 indicates that such sales information is only viewable by certain individuals.

The stored information relating to or associated with the content object may comprise embedded link information, from which the import/export engine 204 may create one or more links for the content object that are accessible through the computer master-client virtual workspace management system 102 in association with the content object (e.g., the content object is presented with converted links accessible through the master-client virtual workspace management system 102). Various embodiments may employ the link engine 218 when creating a link for the content object in accordance with the embedded link information.

Where the content object comprises embedded annotations, the import/export engine 204 may create one or more annotations and associate such annotations with the content object. Various embodiments may employ the master-client virtual workspace annotation engine 216 when creating an annotation for the content object in accordance with the embedded annotation information.

In some embodiments, where a newer version of the content object is imported into the master-client virtual workspace management system 102, the import/export engine 204 may carry over or remap links, annotations, or comments applied to or associated with the older version of the content object (e.g., by way of the master-client virtual workspace management system 102) to the newer version of the content object.

For example, consider where the content object is originally imported from a database source external to the master-client virtual workspace management system 102 and the content object on the database source is updated. In such a situation, the import/export engine 204 may automatically import the updated content object into the master-client virtual workspace management system 102 from the database source, and carry over/remap the links, annotations, and/or comments applied to or associated with the older version of the content object to the updated version of the content object.

In another example, where the content object comprises a word processing document, the seller may instruct the master-client virtual workspace management system 102 to import a newer version of the word processing document (e.g., from their laptop) into the master-client virtual workspace management system 102. As a result, the import/export 204 (of the master-client virtual workspace management system 102) may receive the newer version of the word processing document, optionally use the conversion engine 206 to convert the newer version of the word processing document to a format accessible through the master-client virtual workspace management system 102, and replace the older version of the word processing document on the master-client virtual workspace management system 102 with the newer version of the word processing document (e.g., provide the newer version of the word processing document to the content object management engine 212 for storage, and for replacement of the older version of the word processing document). During this importation process, the import/export engine 204 may also carry over or remap any links, annotations, and/or comments applied to or associated with the older version of the word processing document to the newer version of the word processing document.

As described herein, the links, annotations, and/or comments carried over or remapped to the newer version of the content object (by the import/export engine 204) may have been originally applied or associated with the older version of the content object using the link engine 218, or the master-client virtual workspace annotation engine 216, respectively.

In some embodiments, the import/export engine 204 may enable the seller to export the content object from the master-client virtual workspace management system 102 to an external destination, such a computer system external to the master-client virtual workspace management system 102 (e.g., seller system 104).

In various embodiments, content and/or content objects that are imported into the master-client virtual workspace management system 102 are stored in the content and/or content objects' original format. For example, files in Microsoft Word may be imported into the master-client virtual workspace management system 102 as a Microsoft Word file. Similarly, image files, audio files, video files, spreadsheets, CAD designs, and the like may be imported into the master-client virtual workspace management system 102 in the same format.

In some embodiments, the import/export engine 204 may auto-number the index of content and/or content objects. For example, auto-numbering may indicate which content and/or content objects have been newly imported, as well reduce an amount of time required to number content and/or content objects.

In some embodiments, the conversion engine 206 may be configured to convert some or all content and/or content objects from a native format (e.g., format of the object as it exists on the external database or application) to a format compatible for use (e.g., viewing, modifying, annotating, linking, etc.) through the master-client virtual workspace management system 102.

In one example, the conversion engine 206 may convert documents and/or other files to PDFs to provide a universal format. Other media may be stored as the original content and/or file (e.g., a JPG image may be imported by the import/export engine 204 as a JPG image). By storing at least some content and/or content objects as PDFs, views of the content of the PDFs may be standardized across different platforms and different display sizes. Further, additional information such as annotations, and links may be overlaid within the PDF. In some embodiments, different users may have different rights and/or permissions to view, modify, add, and/or delete all or some overlaid information. For example, a first user may not have access to view or change any overlaid information, while a second user may have access to view annotations and links. A third user may have access to specific annotations but not others. Those skilled in the art will appreciate that any amount of overlaid information may be shared and/or controlled in any number of ways.

In addition, in some embodiments, the conversion engine 206 may convert the content object from a native format to a format that permits the content object to be viewed through the master-client virtual workspace management system 102, that permits the link engine 218 to create a link between a first content object and a second content object, and/or that permits the master-client virtual workspace annotation engine 216 to create an annotation in association with a content object. In some embodiments, the conversion engine 206 may be configured to convert a content object (e.g., received from an external database or application through the import/export engine 204) such that the link engine 218 can create, delete, or modify a link between the computer readable object and another content object. Additionally, the content object may be converted to a format which enables the master-client virtual workspace management system 102 to present the link in conjunction with the content object to which it is associated.

In one example, the native format may comprise a spreadsheet format (e.g., MS Excel format). In some embodiments, the spreadsheet format may be converted to a PDF format, although, in other embodiments, the conversion engine 206 may convert the native spreadsheet format to a non-native spreadsheet format. The non-native spreadsheet format may, for example, provide some or all of the functionality of the native spreadsheet format, e.g., creating, updating, deleting, and/or updating formulae and associated data within the spreadsheet, as well as some additional functionality (e.g., annotating, linking, etc.) without requiring a particular spreadsheet application (e.g., MS Excel) on a client system (e.g., seller systems 104 and/or buyer systems 106) in order to access the spreadsheet. For example, in some embodiments, a web browser may be able to access the non-native spreadsheet and associated features and functionality.

In various embodiments, the conversion engine 206 may convert the content object from a format accessible through the master-client virtual workspace management system 102 to another format as the content object is exported through the import/export engine 204. Furthermore, during a conversion process, the conversion engine 206 may preserve a copy of the content object in its native format for future purposes (e.g., client request a copy of the content object in the material's native form).

In some embodiments, the conversion engine 206 may be automatically employed in converting the content object, as needed, when the content object is imported or exported through the import/export engine 204. In one example, the conversion engine 206 may automatically convert the content object at or near the time the user requests access to the content object (e.g., importation and conversion is performed just-in-time for access). Further, the conversion engine 206 may perform the conversion processes in advance of the user requesting access to the content object (e.g., when the content object has been manually imported and converted into the master-client virtual workspace management system 102 in advance of the seller's access request).

It will be appreciated by those skilled in the art that where the format of the content object is already compatible for access through the master-client virtual workspace management system 102, the conversion engine 206 may not be utilized during importation of the content object into the master-client virtual workspace management system 102. In various embodiments, the accessible format utilized by the master-client virtual workspace management system 102 may differ based on the type of electronic material to be converted. For instance, content objects that are text-based (e.g., such as word processing documents and spreadsheets) and/or based on static images (e.g., slide shows) may be uniformly converted to the viewable format of PostScript Document Format (PDF). In another example, content objects that are a particular audio format, such as MPEG Layer-3 Audio (MP3), Waveform Audio Format (WAV), or Windows Media Audio (WMA), may be reformatted to Ogg Vorbis (OGG).

In some embodiments, the conversion engine 206 may be configured to convert content and/or content objects into a text searchable format, e.g., via optical character recognition (OCR) or similar process. For example, the conversion engine 206 may OCR an image or PDF document, transcribe video and audio documents, and so forth. The searchable content and/or content objects may be stored (e.g., in content object datastore 228) in addition to, or instead of, the native content and/or content object.

In some embodiments, the conversion engine 206 may be configured to convert the content and/or content object to include one or more security features. For example, the conversion engine 206 may associate a watermark with the content and/or content object. The watermark may, for example, be used to verify an authenticity of the content and/or content object.

The master virtual workspace administration engine 208 may be configured to administer or otherwise manage master virtual workspaces. For example, the master virtual workspace administration engine 208 may associate a registered seller with one or more master virtual workspace, define access permissions, such as access control lists and user-role permissions, and otherwise define master virtual workspace parameters. In some embodiments, permissions may be associated with content objects, users (e.g., buyers/sellers), and client-master virtual workspaces. Permissions may be stored in a permissions datastore 234.

The client virtual workspace administration engine 210 may be configured to administer or otherwise manage client virtual workspaces. For example, the client virtual workspace administration engine 210 may associate a registered buyer with one or more client virtual workspaces, define access permissions, such as access control lists and user-role permissions, and otherwise define master virtual workspace parameters. In some embodiments, a user may define access permission for a subset of user. For example, a buyer may comprise a team of buyers. Senior buyer team member may have permissions permitting access to content objects and/or features unavailable to junior team members. In some embodiments, permissions may be associated with content objects, users (e.g., buyers/sellers), and client-master virtual workspaces. Permissions may be stored a permissions datastore 234

The access control engine 212 may be configured to determine, control, and/or enforce permissions. For example, the access control engine 212 may (e.g., by a seller through a master virtual workspace) set permissions and/or rights for sellers and/or groups of sellers (e.g., view-only access to the content object by one or more users or a user group). Similarly, the access control engine 212 may (e.g., by a buyer through a client virtual workspace) set permissions and/or rights for the buyer and/or groups of buyers.

In another example, the access control engine 212 may set user rights and permissions as well as, based on the rights and permissions, determine whether a user can create, delete, and/or modify a link between content objects and/or an annotation in association with a content object. Examples of modifying a link may include, without limitation, changing the endpoints of a link, associating or disassociating an annotation with respect to the link (e.g., where the annotation is created using the master-client virtual workspace annotation engine 216), or permitting a reply annotation to be associated to or disassociated from an annotation already associated with the link (e.g., an annotation that is posted in response to already existing annotation, thereby creating an annotation thread associated with the link).

The master-client virtual workspace generation engine 214 may be configured to create master-client virtual workspaces and associate the master-client virtual workspaces with content objects. In various embodiments, the master-client virtual workspace generation engine 214 may generate a master-client virtual workspace based on the user's rights and permissions. In some embodiments, the master-client virtual workspace generation engine 214 may select a master-client virtual workspace from a plurality of master-client virtual workspaces. In one example, the master-client virtual workspace generation engine 214 may select the master-client virtual workspace based on the user, the user's rights, and/or the user's permissions.

The master-client virtual workspace generation engine 214 may further facilitate the modification or disassociation of virtual workspaces. Various embodiments may utilize the master-client virtual workspaces to organize electronic material according to transactions or deals. Master-client virtual workspaces may provide a context within which a group of content objects may be organized (e.g., directory structure, and object listings), linked together (e.g., with one another or with objects external the embodiment using the link engine 218), or annotated (e.g., annotation applied to and associated with a content object using the master-client virtual workspace annotation engine 216). Additionally, the annotations and links associated with a content object under one master-client virtual workspace may be distinct from those associated with the same content object under another master-client virtual workspace.

In certain embodiments, when a content object is associated with a particular master-client virtual workspace, any links or annotations associated with the content object may also be associated with the virtual workspace. In this way, links or annotations may be sought and located based on their respective association with a given master-client virtual workspace. Additionally, for some embodiments, the master-client virtual workspace may be associated with the user (or a group of users) that includes the user, such that the virtual workspace determines access by the user (or the group of users) to the content object links, annotations, and/or comments associated with the content object.

The master-client virtual workspace annotation engine 216 may be configured to create an annotation and associate the annotation with the content object or a link associated with the content object. For instance, a user may create and associate a comment with a particular point on the timeline of a video file, or create and associate a comment with a section of text in a word processing document. Some exemplary annotations may include text-based comments associated with a content object, image-based comments with a content object, or markups overlaid over content area of a content object. Where the annotation is a text-based comment, the textual content of the annotation may include one or more embedded links associated with resources internal or external to the master-client virtual workspace management system 102. Annotations may include text, video, audio, and/or any kind of media.

In some embodiments, tags may be created and associated with annotations. For example, tags may indicate which users associated with a client-master virtual workspace have permission to access (e.g., create, read, update, and/or delete) associated annotations. For example, a tag may indicate that senior buyer team members may access a particular annotation in a client virtual workspace, while the annotation may be inaccessible to junior buyer team members. Example descriptions of tags and/or tagging may be found, for example, with reference to U.S. Pat. No. 9,424,281, the disclosure of which is incorporated herein by reference in its entirety.

The master-client virtual workspace annotation engine 216 may further facilitate the deletion of annotations, modification of annotations, or disassociation of annotations from content objects. The associations of an annotation with a content objects, and/or links.

The master-client virtual workspace annotation engine 216 may store and/or display threads of annotation. For example, the master-client virtual workspace annotation engine 216 be configured such that a first user can create an annotation in association with the content object and then, subsequently, a second user (or, alternatively, the first user) can create a reply annotation in response to the annotation, which is then associated with the annotation. When a reply annotation is created in response to and associated with a particular annotation, the master-client virtual workspace annotation engine 216 may add the reply annotation to a thread of reply annotations associated with the particular annotation. By maintaining a thread of reply annotations in association with a given annotation of a content object, the master-client virtual workspace annotation engine 216 may facilitate a dialog/discussion between two or more users (e.g., on a team) regarding the given annotation. The dialog/discussion may occur among any number of remote users in real time. Depending on the embodiment, the master-client virtual workspace annotation engine 216 may be configured to maintain two or more separate threads of reply annotations for a given annotation.

Additionally, for various embodiments, the master-client virtual workspace annotation engine 216 may be configured such that a reply annotation by a second user (or, alternatively, a first user) may be created in connection with a link originally created by a first user. The reply annotation may be associated with the entire link (i.e., all endpoints of the link) or a particular endpoint of the link. For some such embodiments, the master-client virtual workspace annotation engine 216 may maintain a thread of reply annotations for a given link of a content object. As noted before, by permitting creation of reply annotations in response to a given link associated with a content object, the master-client virtual workspace annotation engine 216 may facilitate a dialog/discussion between two or more users (e.g., on a team) regarding the given link. Depending on the embodiment, the master-client virtual workspace annotation engine 216 may be configured to maintain two or more separate threads of reply annotations for a given link.

For example, the master-client virtual workspace annotation engine 216 may create an annotation in association with a content object (e.g., first user creates an annotation in association with a content object already annotated by the system by a second user), or remove an annotation from a content object, associate an annotation with a link in a content object (e.g., a first user's reply annotation to a link created in the content object by a second user). In addition, the master-client virtual workspace annotation engine 216 may be further configured to generate a summary of annotations associated with a particular content object (e.g., the first content object).

The master-client virtual workspace annotation engine 216 may be further configured to generate a notification when an action is performed in association with the annotation. A first user or administrator may have rights or permissions to identify one or more other users to receive notifications when an annotation, and/or link are created. For example, a user may identify groups of individuals who will work collaboratively such that when any member of the group makes changes, adds or modifies annotations, or the like, the rest of the group is notified. In some embodiments, the notification includes a link to one or more different changes to content and/or content objects. The rights and/or permissions of specific users may also be controlled such that all or part of one or more threads may be viewed or changed by a limited number of users.

In some embodiments, a user may also associate a link with or disassociate a link from an annotation (e.g., an annotation created using the master-client virtual workspace annotation engine 216), and/or view or respond to an annotation already associated with the link (e.g., respond to an existing annotation with another annotation using the master-client virtual workspace annotation engine 216).

The link engine 218 may be configured to may be configured to create, delete, or modify a link between the content object and another content object. In one example, the link engine 218 may enable a user to create a link from a section of text in a word processing document to a specific position in an audio file (i.e., a location in the timeline of the audio file). In this example, a text transcript may include links to a media file thereby allowing a user to select relevant portions of the text transcript and be linked to the relevant portion of a video deposition.

In another example, the link engine 218 may enable a user to change an endpoint of a link, or modify the type of link created between the two content objects (e.g., one-way link, two-way link). When a link is created, the link engine 218 may also associate the link with the content object, an annotation, or the user creating the link. For some embodiments, such associations may permit the user to search for, or obtain a listing of, content objects, annotations, or users based on a link.

The master-client virtual workspace comment generation engine 220 may be configured to generate comments that may be communicated between master client virtual workspaces and client virtual workspaces. For example, the master-client virtual workspace comment generation engine 220 may include similar functionality as the master-client virtual workspace annotation engine 216, albeit as adapted for provisioning across master-client workspaces, whereas annotations may be restricted to the local client-master virtual workspace.

In some embodiments, the master-client virtual workspace comment generation engine 220 functions to generate comments within a master-client virtual workspace for publication to a different master-client virtual workspace, depending on access control permissions, as described elsewhere herein. For example, the master-client virtual workspace comment generation engine 220 may function to generate comments within a client virtual workspace for publication to one or more master virtual workspaces, and vice versa. As discussed herein, comments can include questions, e.g., questions from a buyer to a seller regarding a particular transaction and/or content object.

In some embodiments, the linking engine 218 further functions to link comments to annotations and/or content objects, or portion thereof, and each party (e.g., seller or buyers) may have access to the link within the context of their respective master-client virtual workspace. For example, the master-client virtual workspace comment generation engine 220 may generate a comment in a client virtual workspace, and the link engine 218 may link the comment to a portion of a content object by linking the comment to a corresponding portion of an instance of the content object associated with the client virtual workspace (e.g., as opposed to the content object itself stored in the content object stored in content object datastore 232). In some embodiments, if the comment is published to a different master-client virtual workspace (e.g., a master virtual workspace), as discussed further below, the links are remapped to link to a different instance of the content object that is local to the different master-client virtual workspace. In some embodiments, instead of or in addition to remapping, the link may be removed altogether depending on access control permissions (e.g., by redaction engine 226, discussed below).

The master-client virtual workspace comment publication engine 222 may be configured to provide comments between master virtual workspaces and client virtual workspaces. In some embodiments, the publication engine 222 may provide comments between virtual workspaces based on access control permissions, e.g., access control lists or user-role based permissions. For example, the publication engine 222 may cooperate with the access control engine 212 to determine whether a user has sufficient permission to publish comments, and only publish comments in response to input from users with sufficient permissions.

The analytics and reporting engine 224 may be configured to capture buyer activity within client virtual workspaces. For example, buyer activity may include the number of times a buyer has viewed particular documents, the number of comments provided by a buyer, and the like. In some embodiments, the master-client virtual workspace management system 102 is configured to generate reports based on captured activity. For example, the reports may indicate which buyers are legitimate, as opposed to buyers that may merely be trolling for information. In some embodiments, the analytics and reporting engine 224 may generate transaction documents (e.g., due diligence documents) that may be presented to the seller and/or third-party entities associated with the transaction, such as financial institutions.

The redaction engine 226 may be configured to redact some or all portions of content objects based on access control permissions. In some embodiments, content objects associated with comments may be redacted if the intended recipient of the comment does not have sufficient permission to view some or all portions of the content object. For example, a seller may intend to provide a particular document to a variety of buyers. However, the document may be associated with an access control permission indicated that particular portions of the document may be accessed by buyers with particular level of permissions. The redaction engine 226 may redact portions of the document viewed by the buyers with insufficient permissions, while buyers with sufficient permissions may view the entire document.

The communication engine 228 may be configured to send requests, transmit and, receive communications, and/or otherwise provide communication with one or a plurality of systems. In some embodiments, the communication engine 228 may be configured to encrypt and decrypt communications. The communication engine 228 may send requests to and receive data from a system through a network or a portion of a network. Depending upon implementation-specific or other considerations, the communication engine 228 may send requests and receive data through a connection, all or a portion of which may be a wireless connection. The communication engine 228 may request and receive messages, and/or other communications from associated systems.

The management engine 230 may be configured to manage (e.g., create, read, update, delete, or otherwise access) content objects stored in the content object datastore 232, permissions stored in the permission datastore 234, comments stored in the comment datastore 236, annotations stored in the annotation datastore 238, and links stored in the link datastore 310. The datastores 230-240 may be any suitable structure (e.g., an active database, a relational database, a self-referential database, a table, a matrix, an array, a flat file, a documented-oriented storage system, a non-relational No-SQL system, and the like). In some embodiments, the functionality of the management engine 230 may be included in one or more other engines of the system 102.

The management engine 230 may further facilitate the deletion, modification or disassociation of master-client virtual workspaces. Various embodiments may utilize the master-client virtual workspace to organize electronic material according to projects and/or matters being performed by the user and associated with the master-client virtual workspace. A master-client virtual workspace may provide a context within which a group of content objects may be organized (e.g., directory structure, and object listings), linked together (e.g., with one another or with objects external the embodiment using the link engine 218), or annotated (e.g., annotation applied to and associated with a content object using the master-client virtual workspace annotation engine 216). Additionally, the annotations and links associated with a content object under one master-client virtual workspace may be distinct from those associated with the same content object under another master-client virtual workspace.

In certain embodiments, when a content object is associated with a particular virtual master-client workspace, any links, annotations, or comments associated with the content object may also be associated with the master-client virtual workspace. In this way, links, annotations, and/or comments may be sought and located based on their respective association with a given virtual workspace. Additionally, for some embodiments, the virtual workspace may be associated with the user (or a group of users) that includes the user, such that the virtual workspace determines access by the user (or the group of users) to the content object links, and/or annotations or comments associated with the content object. The content object datastore 232 may be configured to persistently or temporarily store content objects (e.g., store a content object that is imported into the content object system 100 through the import/export engine 204). In some embodiments, the content object datastore 228 may comprise a file server, which may have a directory structure for storing and organizing content objects, and which may use a directory and/or file naming convention used in identifying the content object, associating the computer readable content with another the content object, or with information conveying information relating to the content object (e.g., the date of importation, the import source, or the file type for the content object). Additionally, in some embodiments, the content object datastore 228 may store an association of a content object stored on the content object datastore 228 with a link created by the link engine 218.

The permissions datastore 234 may be configured to permissions associated with content objects, links, users, and/or master-client virtual workspaces. For example, permissions may include access control lists and/or user-role based permissions.

The comment datastore 236 may be configured to store comments provided between master-client workspaces and comment drafts. For example, a generated comment awaiting publication by a user with sufficient permission to publish the comment may be saves as a draft until published.

The annotations datastore 238 may be configured to store contents of an annotation created by the master-client virtual workspace annotation engine 216, an association of the annotation to the content and/or content object, or an association of the annotation to a link created by the link engine 218.

The link datastore 240 may be configured to store a link created between different kinds of content, a link created between content objects, or an association of the link to an annotation created by the master-client virtual workspace annotation engine 216.

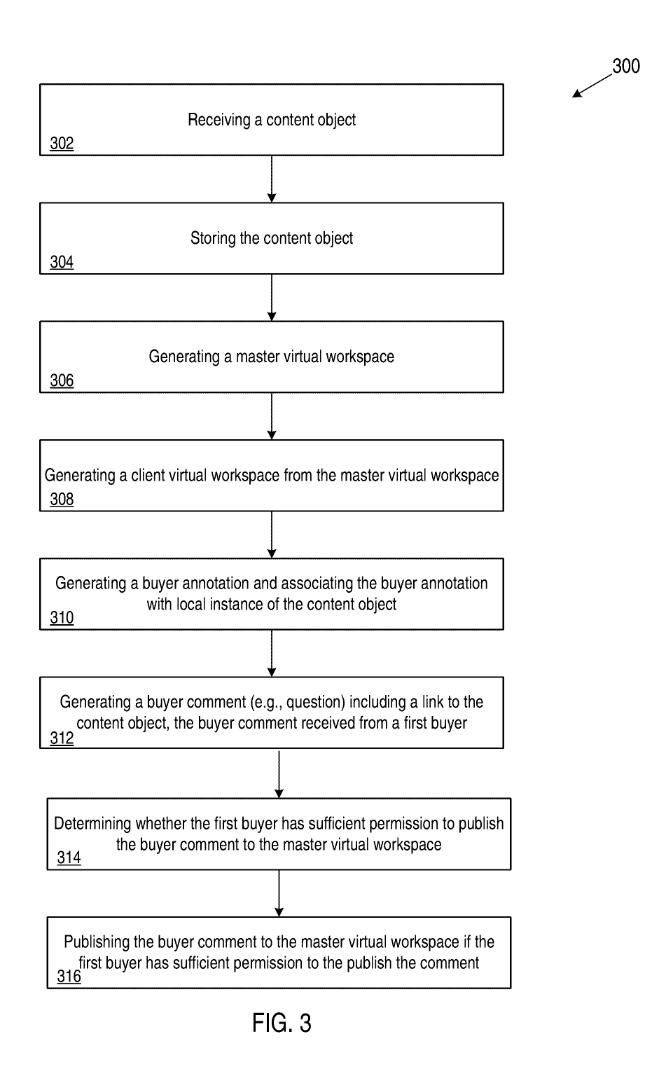

FIG. 3 depicts a flowchart 300 of an example method of operation of a master-client virtual workspace management system 102 according to some embodiments. In this and other flowcharts, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 302, a master-client virtual workspace management system 102 receives a content object from a remote system associated with a seller. In some embodiments, the seller may be associated with a sale or other transaction (e.g., lease, etc.). In some embodiments, an import/export engine 204 receives the content object. In various embodiments, the import/export engine 204 may receive the content object as content, and the content may be converted into the content object, e.g., by a conversion engine 206.

In step 304, the master-client virtual workspace management system 102 stores the content object in a content object datastore. In some embodiments, a management engine 230 stores the content object in a content object datastore 232.

In step 306, the master-client virtual workspace management system 102 generates a master virtual workspace and associates the master virtual workspace with the seller. In some embodiments, the master virtual workspace comprises a first instance of the content object. In some embodiments, a master-client virtual workspace generation engine 214 generates and associates the master virtual workspace.

In step 308, the master-client virtual workspace management system 102 generates a client virtual workspace from the master virtual workspace and associates the client virtual workspace with one or more buyers. In some embodiments, the one or more buyers are associated with the sale or other transaction, and the client virtual workspace comprises a second instance of the content object. In some embodiments, the client virtual workspace comprises a mirror of the master virtual workspace. In some embodiments, the master-client virtual workspace generation engine 214 generates and associates the client virtual workspace.

In step 310, the master-client virtual workspace management system 102 generates a buyer annotation and associates the buyer annotation with the second instance of the content object. In some embodiments, the buyer annotation is unavailable to the master virtual workspace. In some embodiments, a master-client virtual workspace annotation engine 216 generates and associates the buyer annotation.

In step 312, the master-client virtual workspace management system 102 generates a buyer comment including a link to the content object. In some embodiments, the buyer comment is received from a first buyer of the one or more buyers. In some embodiments, a master-client virtual workspace comment generation engine 220 generates and associates the buyer comment.

In step 314, the master-client virtual workspace management system 102 determines whether the first buyer of the one or more buyers has sufficient permission to publish the buyer comment to the master virtual workspace. In some embodiments, an access control engine 212 performs the determination.

In step 316, the master-client virtual workspace management system 102 publishes the buyer comment to the master virtual workspace if the first buyer of the one or more buyers has the sufficient permission to publish the comment to the master virtual workspace. In some embodiments, if the first buyer does not have sufficient permission to publish the buyer, a different buyer with sufficient permission may be required and/or requested to review, edit, and/or publish the buyer comment. In some embodiments, a master-client virtual workspace publication engine 222 performs the publication.

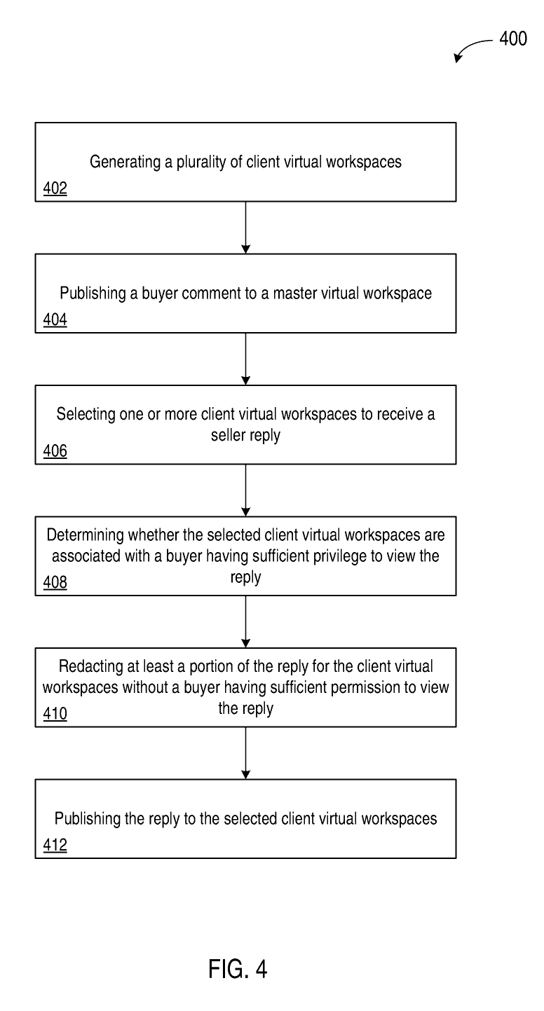

FIG. 4 depicts a flowchart 400 of an example method of operation of a master-client virtual workspace management system 102 according to some embodiments.

In step 402, a master-client virtual workspace management system 102 generates a plurality of client virtual workspaces, at least one of the plurality of client virtual workspaces associated with a different buyer (or, buyer “team”). For example, a first buyer may be associated with at least one virtual client workspace, and a second buyer may be associated with at least one different client virtual workspace, and so forth. In some embodiments, a master-client virtual workspace generation engine 214 generates and associates the master virtual workspace.

In step 404, the master-client virtual workspace management system 102 publishes a buyer comment to a master virtual workspace. For example, a particular buyer may input a question through an associated client virtual workspace, and the question may be provided to the appropriate master virtual workspace in response to verification of the buyer's permissions. In some embodiments, a master-client virtual workspace publication engine 222 performs the publication, and an access control engine 212 performs the permission determination.

In step 406, the master-client virtual workspace management system 102 selects one or more buyers to receive a reply to the comment. For example, the seller may view the comment, provide (e.g., generate) the reply, select one or more recipients, all through the master virtual workspace. In some embodiments, the master-client virtual workspace comment generation engine 220 provides and/or selects recipients of the reply.

In step 408, the master-client virtual workspace management system 102 determines whether the selected one or more buyers have sufficient permission to view the reply. In step 410, the master-client virtual workspace management system 102 redacts at least a portion of the reply to buyers that do not have sufficient privileges to view or otherwise access at least a portion of the reply. For example, the reply may include a content object which an intended recipient does not have permission to view, or only has sufficient privilege to view or otherwise access a portion thereof. In some embodiments, an access control engine 212 performs the determination. In some embodiments, a redaction engine 226 performs the redaction.

In step 412, the master-client virtual workspace management system 102 publishes the reply to the selected recipients, including any redacted replies. Thus, for example, a first client virtual workspace associated with a first buyer may receive a complete reply comment, while a different client virtual workspace associated with a different buyer may receive a redacted reply comment. In some embodiments, a master-client virtual workspace publication engine 222 performs the publication.

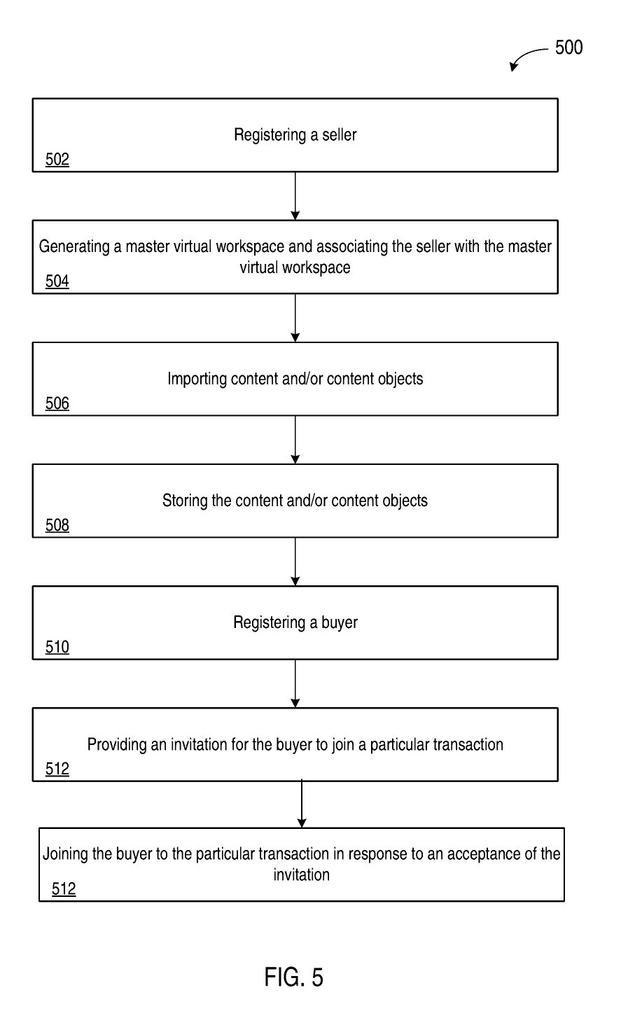

FIG. 5 depicts a flowchart 500 of an example method of operation of a master-client virtual workspace management system 102 according to some embodiments.

In step 502, a master-client virtual workspace management system 102 registers a seller account. For example, the seller account may include a seller id, seller contact information, and the like. In some embodiments, the system 102 may provide for anonymous transactions, in which case an identity of the seller may not be required. In other embodiments, a seller's identify may need to be provided, and in some embodiments, verified, in order to complete the seller registration. In some embodiments, a registration engine 202 performs the seller registration.

In step 504, a master-client virtual workspace management system 102 generates a master virtual workspace and associates the master virtual workspace with the seller in response to successful seller registration. In some embodiments, a master-client virtual workspace generation engine 214 generates and associates the master virtual workspace.

In step 506, a master-client virtual workspace management system 102 imports content provided from a remote seller system 104 associated with the seller. In some embodiments, the master-client virtual workspace management system 102 may OCR the content and convert the content into one or more content objects. In some embodiments, an import/export engine 204 receives the content. In some embodiments, a conversion engine 206 performs the conversion.

In step 508, a master-client virtual workspace management system 102 stores the content and/or content object. In some embodiments, a management engine 230 stores the content and/or content object in a content object datastore 232.

In step 510, a master-client virtual workspace management system 102 registers a buyer account. For example, the buyer account may include a buyer id, buyer contact information, and the like. In some embodiments, the system 102 may provide for anonymous transactions, in which case an identity of the buyer may not be required. In other embodiments, a buyer's identify may need to be provided, and potentially verified, in order to complete buyer registration. In some embodiments, the registration engine 202 performs the buyer registration.

In step 512, a master-client virtual workspace management system 102 provides an invitation to the registered buyer to join a particular transaction (or, “deal”). In some embodiments, the system 102 may invite the registered buyer in response to input received from a seller through a master virtual workspace. For example, the seller may select from a list of potential buyers (e.g., buyers interested in a particular type of transaction), specifically enter an ID of a particular buyer, and so forth. In some embodiments, the registration engine 202 provides the invitation.

In step 514, the master-client virtual workspace management system 102 receives an invitation response from the registered buyer, and if the invitation is accepted, joins the registered buyer to the transaction. In some embodiments, the registration engine 202 receives the invitation response.

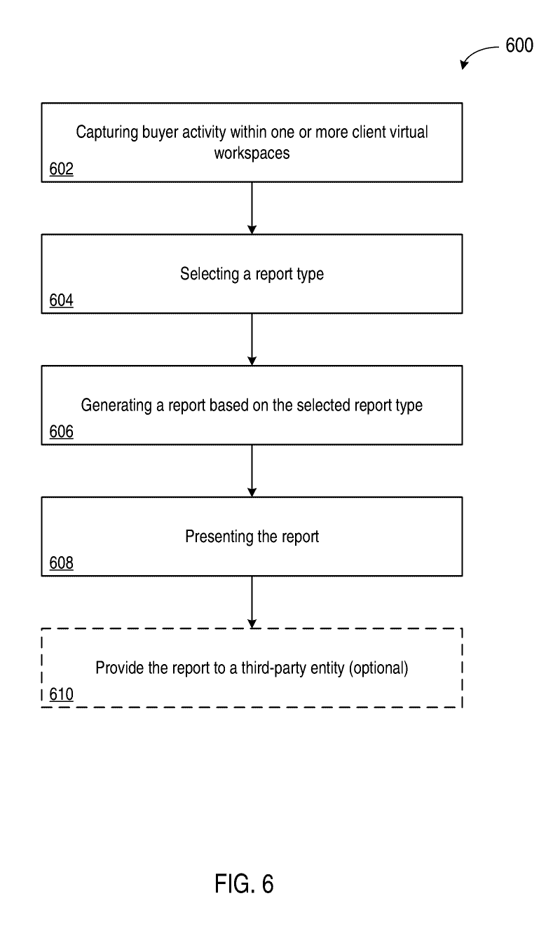

FIG. 6 depicts a flowchart 600 of an example method of operation of a master-client virtual workspace management system 102 according to some embodiments.

In step 602, a master-client virtual workspace management system 102 captures buyer activity within one or more client virtual workspaces. For example, activity may include the comments provide between buyers and the seller, the number of views of various documents, and the like. Captured activity may be stored in system 102 datastore. In some embodiments, an analytics and reporting engine 224 captures the buyer activity.

In step 604, the master-client virtual workspace management system 102 selects a report type. For example, the report type may include an activity report which may indicate the most active users, which may be used to identify legitimate buyers from other buyers. In some embodiments, the report may include due diligence reports and other reports that may be used by one or more third-party entities associated with the transaction, e.g., financial institutions, legal representatives, etc. In some embodiments, the analytics and reporting engine 224 selects the report. In various embodiments, the analytics and reporting engine 224 selects the report type in response to user input (e.g., seller input received through an interface of the master virtual space) and/or automatically (e.g., without requiring user input).

In step 606, the master-client virtual workspace management system 102 generates the requested report. In some embodiments, the analytics and reporting engine 224 generates the report.

In step 608, the master-client virtual workspace management system 102 presents the report to the seller. For example, the report may be presented through a graphical user interface associated with the master virtual workspace as chart, graph, numerical values, text, images, and the like. In some embodiments, client-master virtual workspaces include a GUI component, while in other embodiments, the GUI component may be distinct from the client-master workspaces, although the functionality discussed herein may remain the same.

In step 610, the master-client virtual workspace management system 102 may optionally provide the report (e.g., due diligence report) to one or more third-party entities. For example, the report may be provided automatically in response to a trigger condition (e.g., upon conclusion of a transaction or transaction event), and/or in response to seller input. In some embodiments, a communication engine 228 provides the report to the one or more third-party entities.

FIG. 7 depicts a screenshot of an example interface 700 associated with a master virtual workspace according to some embodiments. Although example interfaces discussed herein are shown with respect to a master virtual workspace, it will be appreciated that a client virtual workspace may be associated with similar example interfaces, albeit with functionality in accordance with tools and features associated with a client virtual workspace.

In some embodiments, the interface 700 may be generated and provided to a seller (e.g., at a seller system 104) by a master-client workspace generation engine 214. As shown, the interface 700 includes a taskbar 702 with a documents tab 704, a notes tab 706, a Q&A tab (or “comment” tab) 708, an activity tab 710, a search tab 712, and an admin tab 714. The taskbar 702 may be used to navigate between the various features and tools of a master virtual workspace. The interface 700 further includes preview panels 716-722 presenting a preview of the documents section, a preview of the notes section, a preview of the Q&A section, and a preview of the activity section.

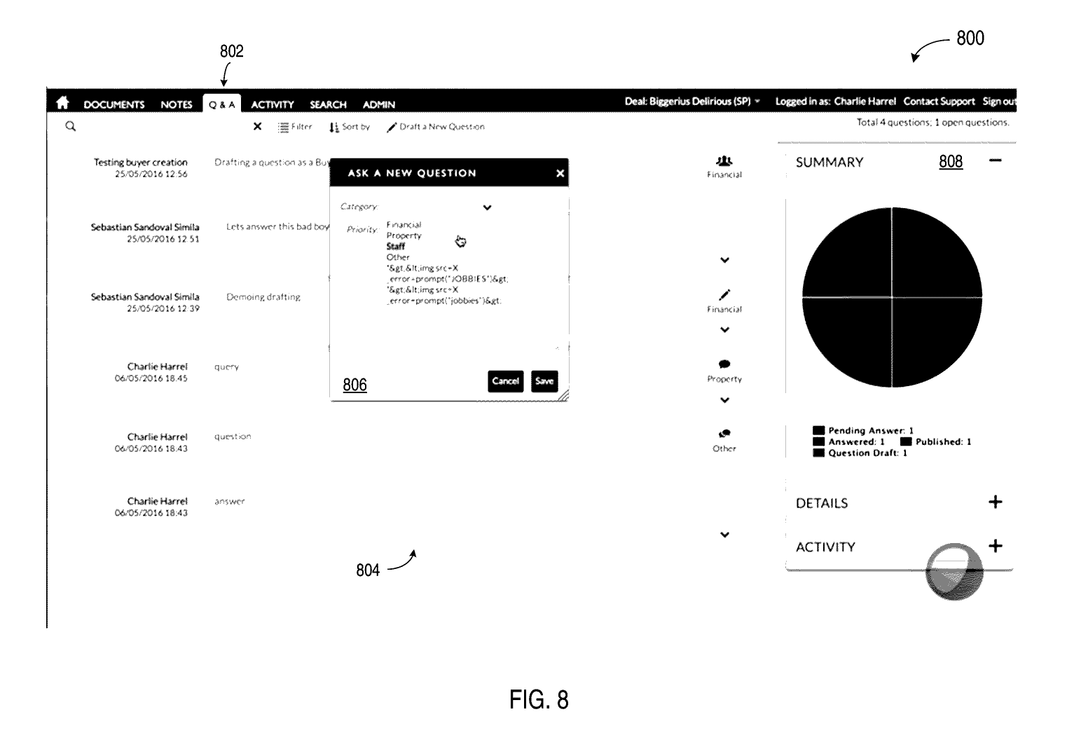

FIG. 8 depicts a screenshot of an example interface 800 associated with a master virtual workspace according to some embodiments. In some embodiments, the interface 800 may be generated and provided to a seller (e.g., at a seller system 104) by a master-client workspace generation engine 214. As shown, the interface 800 presents the Q&A section 802 including a plurality panels 804 associated with a comment thread, a new comment dialogue box 806, and a comment summary panel 808. It will be appreciated that as used herein, a question comprises a particular of type of comment.

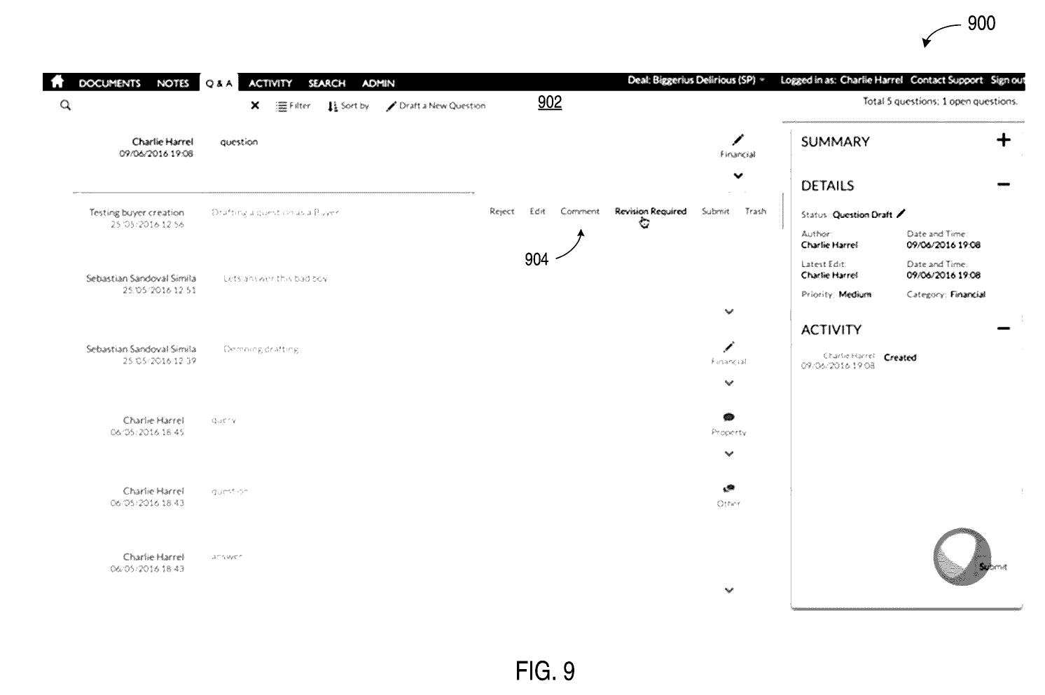

FIG. 9 depicts a screenshot of an example interface 900 associated with a master virtual workspace according to some embodiments. In some embodiments, the interface 900 may be generated and provided to a seller (e.g., at a seller system 104) by a master-client workspace generation engine 214. As shown, the interface 900 presents an example Q&A section 802 including a panel 804 for rejecting a comment, editing a comment, indicating that a revision is required, submitting a comment, and deleting a comment.

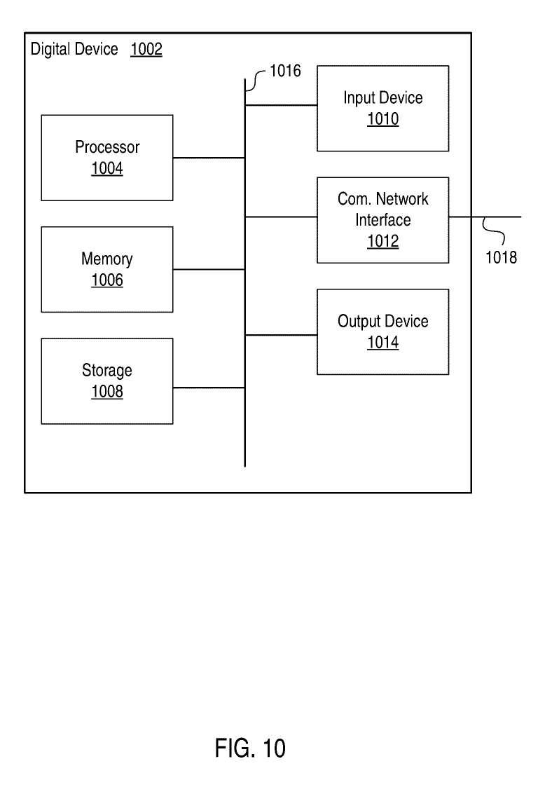

FIG. 10 depicts a block diagram 1000 of an example computing device 1002 according to some embodiments. Any of the master-client virtual workspace management engine 102, the seller systems 104, the buyer systems 106, and the communication network 108 may comprise an instance of the digital device 1002. The digital device 1002 comprises a processor 1004, memory 1006, storage 1008, an input device 1010, a communication network interface 1012, and an output device 1014 communicatively coupled to a communication channel 1016. The processor 1004 is configured to execute executable instructions (e.g., programs). In some embodiments, the processor 1004 comprises circuitry or any processor capable of processing the executable instructions.

The memory 1006 stores data. Some examples of memory 1006 include storage devices, such as RAM, ROM, RAM cache, virtual memory, etc. In various embodiments, working data is stored within the memory 1006. The data within the memory 1006 may be cleared or ultimately transferred to the storage 1008.

The storage 1008 includes any storage configured to retrieve and store data. Some examples of the storage 1008 include flash drives, hard drives, optical drives, and/or magnetic tape. Each of the memory system 1006 and the storage system 1008 comprises a computer-readable medium, which stores instructions or programs executable by processor 1004.

The input device 1010 is any device that inputs data (e.g., mouse and keyboard). The output device 1014 outputs data (e.g., a speaker or display). It will be appreciated that the storage 1008, input device 1010, and output device 1014 may be optional. For example, the routers/switchers may comprise the processor 1004 and memory 1006 as well as a device to receive and output data (e.g., the communication network interface 1012 and/or the output device 1014).

The communication network interface 1012 may be coupled to a network (e.g., network 108) via the link 1018. The communication network interface 1012 may support communication over an Ethernet connection, a serial connection, a parallel connection, and/or an ATA connection. The communication network interface 1012 may also support wireless communication (e.g., 1102.11 a/b/g/n, WiMax, LTE, WiFi). It will be apparent that the communication network interface 1012 may support many wired and wireless standards.

It will be appreciated that the hardware elements of the digital device 1002 are not limited to those depicted in FIG. 10. A digital device 1002 may comprise more or less hardware, software and/or firmware components than those depicted (e.g., drivers, operating systems, touch screens, biometric analyzers, or the like). Further, hardware elements may share functionality and still be within various embodiments described herein. In one example, encoding and/or decoding may be performed by the processor 1004 and/or a co-processor located on a GPU (i.e., NVidia).

It will be appreciated that a “engine,” “system,” and/or “datastore” may comprise software, hardware, firmware, and/or circuitry. In one example, one or more software programs comprising instructions capable of being executable by a processor may perform one or more of the functions of the engines, datastore, or systems described herein. In another example, circuitry may perform the same or similar functions. Alternative embodiments may comprise more, less, or functionally equivalent engines, systems, and/or datastores, and still be within the scope of present embodiments. For example, the functionality of the various systems, engines, and/or datastores may be combined or divided differently.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A system, comprising:
a processor;
a content object datastore;
an import engine configured to cooperate with the processor to receive a content object from a remote system associated with a seller, the seller associated with a sale;
a management engine configured to store the content object in the content object datastore;
a master-client virtual workspace generation engine configured to generate a master virtual workspace associated with the seller, and configured to generate a client virtual workspace from the master virtual workspace, the client virtual workspace associated with one or more buyers, the one or more buyers associated with the sale, the master virtual workspace comprising a first instance of the content object, and the client virtual workspace comprising a second instance of the content object;
a master-client virtual workspace annotation engine configured to generate a buyer annotation, and configured to associate the buyer annotation with the second instance of the content object, the buyer annotation unavailable to the master virtual workspace;
a master-client virtual workspace comment generation engine configured to generate a buyer comment, the buyer comment including a link to the content object, the buyer comment received from a first buyer of the one or more buyers;
an access control engine configured to determine whether the first buyer of the one or more buyers has sufficient permission to publish the buyer comment to the master virtual workspace; and
a master-client virtual workspace comment publication engine configured to publish the buyer comment to the master virtual workspace if the first buyer of the one or more buyers has the sufficient permission to publish the comment to the master virtual workspace.

2. The system of claim 1, wherein the buyer annotation comprises any of a text-based annotation associated with the content object, an image-based annotation associated with the content object, or markups overlaid over a content area of the content object.

3. The system of claim 1, wherein the buyer comment comprises a question directed to the seller.

4. The system of claim 3, wherein a format of the question comprises any of text, audio, image, or video.

5. The system of claim 1, wherein the access control is configured to determine whether the first buyer of the one or more buyers has sufficient permission to publish the buyer comment to the master virtual workspace based on an access control list (ACL) associated with the client virtual workspace.

6. The system of claim 1, wherein the access control engine is configured to determine whether the first buyer of the one or more buyers has sufficient permission to publish the buyer comment to the master virtual workspace based on a user role associated with the first buyer of the one or more buyers.

7. The system of claim 1, wherein the master-client virtual workspace comment generation engine is configured to receive a seller reply to the buyer comment, the seller reply received from the seller through the master virtual workspace.

8. The system of claim 7, wherein the master virtual workspace comment publication engine is further configured to select one or more buyers to receive the seller reply, and publish the seller reply to the one or more client virtual workspaces associated with the one or more buyers.

9. The system of claim 8, wherein the access control engine is further configured to determine, prior to the publication of the seller reply to the one or more client virtual workspaces associated with the one or more buyers, whether each of the one or more buyers have sufficient permission to access some or all of the seller reply, and redact one or more portions of the seller reply to a particular one of the one or more buyers if the particular one of the one or more buyers does not have sufficient permission to access some or all of the seller reply.

10. A method, comprising:
receiving, by a master-client virtual workspace management engine, a content object from a remote system associated with a seller, the seller associated with a sale;
storing, by the master-client virtual workspace management engine, the content object in the content object datastore;
generating, by the master-client virtual workspace management engine, a master virtual workspace associated with the seller, and configured to generate a client virtual workspace from the master virtual workspace, the client virtual workspace associated with one or more buyers, the one or more buyers associated with the sale, the master virtual workspace comprising a first instance of the content object, and the client virtual workspace comprising a second instance of the content object;
generating, by the master-client virtual workspace management engine, a buyer annotation, and associating by the master-client virtual workspace management engine, the buyer annotation with the second instance of the content object, the buyer annotation unavailable to the master virtual workspace;
generating, by the master-client virtual workspace management engine, a buyer comment, the buyer comment including a link to the content object, the buyer comment received from a first buyer of the one or more buyers;
determining, by the master-client virtual workspace management engine, whether the first buyer of the one or more buyers has sufficient permission to publish the buyer comment to the master virtual workspace; and
publishing, by the master-client virtual workspace management engine, the buyer comment to the master virtual workspace if the first buyer of the one or more buyers has the sufficient permission to publish the comment to the master virtual workspace.

11. The method of claim 10, wherein the buyer annotation comprises any of a text-based annotation associated with the content object, an image-based annotation associated with the content object, or markups overlaid over a content area of the content object.

12. The method of claim 10, wherein the buyer comment comprises a question directed to the seller.

13. The method of claim 12, wherein a format of the question comprises any of text, audio, image, or video.

14. The method of claim 10, wherein the determining whether the first buyer of the one or more buyers has sufficient permission to publish the buyer comment to the master virtual workspace is based on an access control list (ACL) associated with the client virtual workspace.

15. The method of claim 10, wherein the determining whether the first buyer of the one or more buyers has sufficient permission to publish the buyer comment to the master virtual workspace is based on a user role associated with the first buyer of the one or more buyers.

16. The method of claim 10, further comprising receiving a seller reply to the buyer comment, the seller reply received from the seller through the master virtual workspace.

17. The method of claim 16, further comprising selecting one or more buyers to receive the seller reply, and publishing the seller reply to the one or more client virtual workspaces associated with the one or more buyers.

18. The method of claim 17, further comprising, prior to the publishing of the seller reply to the one or more client virtual workspaces associated with the one or more buyers, whether each of the one or more buyers have sufficient permission to access some or all of the seller reply, and redacting one or more portions of the seller reply to a particular one of the one or more buyers if the particular one of the one or more buyers does not have sufficient permission to access some or all of the seller reply.

19. A non-transitory computer readable medium comprising executable instructions, the instructions being executable by a processor to perform a method, the method comprising:
receiving a content object from a remote system associated with a seller, the seller associated with a sale;
storing the content object in the content object datastore;
generating a master virtual workspace associated with the seller, and configured to generate a client virtual workspace from the master virtual workspace, the client virtual workspace associated with one or more buyers, the one or more buyers associated with the sale, the master virtual workspace comprising a first instance of the content object, and the client virtual workspace comprising a second instance of the content object;
generating a buyer annotation, and associating by the master-client virtual workspace management engine, the buyer annotation with the second instance of the content object, the buyer annotation unavailable to the master virtual workspace;
generating a buyer comment, the buyer comment including a link to the content object, the buyer comment received from a first buyer of the one or more buyers;
determining whether the first buyer of the one or more buyers has sufficient permission to publish the buyer comment to the master virtual workspace; and
publishing, by the master-client virtual workspace management engine, the buyer comment to the master virtual workspace if the first buyer of the one or more buyers has the sufficient permission to publish the comment to the master virtual workspace.

20. A system, comprising:
a means for receiving a content object from a remote system associated with a seller, the seller associated with a sale;
a means for storing the content object in the content object datastore;
a means for generating a master virtual workspace associated with the seller, and configured to generate a client virtual workspace from the master virtual workspace, the client virtual workspace associated with one or more buyers, the one or more buyers associated with the sale, the master virtual workspace comprising a first instance of the content object, and the client virtual workspace comprising a second instance of the content object;
a means for generating a buyer annotation, and associating by the master-client virtual workspace management engine, the buyer annotation with the second instance of the content object, the buyer annotation unavailable to the master virtual workspace;
a means for generating a buyer comment, the buyer comment including a link to the content object, the buyer comment received from a first buyer of the one or more buyers;
a means for determining whether the first buyer of the one or more buyers has sufficient permission to publish the buyer comment to the master virtual workspace; and
publishing, by the master-client virtual workspace management engine, the buyer comment to the master virtual workspace if the first buyer of the one or more buyers has the sufficient permission to publish the comment to the master virtual workspace.
